(19) United States
(12) Patent Application Publication
(10) Pub. No.: US 2019/0220777 A1
(43) Pub. Date: Jul. 18, 2019

(54) SYSTEM AND METHOD FOR IMPLEMENTING A CLIENT SENTIMENT ANALYSIS TOOL

(71) Applicant: JPMorgan Chase Bank, N.A., New York, NY (US)

(72) Inventors: Steven Brook JOHNSON, Ringwood (GB); Alison DORAN, Bournemouth (GB); David GLADWIN, Bournemouth (GB); Greta ONGARO, Gandino (IT); Sam HAYNES, Bournemouth (GB); Connie BLACKLOCK, Whiteparish (GB); Yawwani GUNAWARDANA, Southampton (GB); Joe TILSED, Bournemouth (GB); Isabella RULE, Poole (GB); Mark R. WILLIAMS, Dorset (GB); Nathan P. HOTCHKIN, Charlton (GB); Erin BREEN, Poole (GB); Tamanna BEGUM, Poole (GB); Joe J. BOTTIGLIERI, Bournemouth (GB)

(21) Appl. No.: 16/249,340

(22) Filed: Jan. 16, 2019

Related U.S. Application Data
(60) Provisional application No. 62/617,782, filed on Jan. 16, 2018.

(51) Int. Cl. G06N 20/00; G06F 9/54

(52) U.S. Cl. CPC G06N 20/00; G06F 9/54

(57) ABSTRACT

According to an embodiment of the present invention, a Sentiment Analyzer Tool comprises: a data repository; a user interface that graphically presents metrics based on the sentiment data; an application program interface and a processor configured to perform: receiving, via an electronic input, real-time customer communication; extracting, via the processor, text data from the real-time customer communication; generating, via the processor, a customer sentiment score based on the text data; comparing, via the processor, the customer sentiment score to a threshold value to determine a positive sentiment, neutral sentiment or negative sentiment; and graphically representing, via the interactive user interface, the customer sentiment score as compared to sentiment data associated with a plurality of other customers wherein the interactive user interface displays overall sentiment data, sentiment data over a predetermined period of time and a combination of: emotion data, social tendencies data and language style data.

### CROSS REFERENCE TO RELATED APPLICATIONS

The application claims priority to U.S. Provisional Application 62/617,782 (Attorney Docket No. 72167.001360), filed Jan. 16, 2018, the contents of which are incorporated herein in its entirety.

### FIELD OF THE INVENTION

The invention relates generally to a system and method for analyzing client sentiment.

### BACKGROUND OF THE INVENTION

Measuring client sentiment is subjective and inconsistent, resulting in delayed escalations to senior management. Current systems do not provide training tools for Client Service teams to suggest language and emotional intelligence improvements to communications before they are sent to the client. With limits in current systems, client issues are not being properly addressed early enough and before client frustration reaches a critical point.

These and other drawbacks exist.

### SUMMARY OF THE INVENTION

According to one embodiment, the invention relates to a system that implements a Sentiment Analyzer Tool. The system comprises: a data repository that stores and maintains sentiment data; a user interface that graphically presents metrics based on the sentiment data; an application program interface in communication with the data repository and the user interface; and a processor, coupled to the data repository, the user interface and application program interface, configured to perform the steps of: receiving, via an electronic input, real-time customer communication; extracting, via the processor, text data from the real-time customer communication; generating, via the processor, a customer sentiment score based on the text data; comparing, via the processor, the customer sentiment score to a threshold value to determine a positive sentiment, neutral sentiment or negative sentiment; and graphically representing, via the interactive user interface, the customer sentiment score as compared to sentiment data associated with a plurality of other customers wherein the interactive user interface displays overall sentiment data, sentiment data over a predetermined period of time and a combination of: emotion data, social tendencies data and language style data.

According to another embodiment, the invention relates to a method for implementing a Sentiment Analyzer Tool. The method comprises the steps of: receiving, via an electronic input, real-time customer communication; extracting, via a processor, text data from the real-time customer communication; generating, via the processor, a customer sentiment score based on the text data; comparing, via the processor, the customer sentiment score to a threshold value to determine a positive sentiment, neutral sentiment or negative sentiment; and graphically representing, via the interactive user interface, the customer sentiment score as compared to sentiment data associated with a plurality of other customers wherein the interactive user interface displays overall sentiment data, sentiment data over a predetermined period of time and a combination of: emotion data, social tendencies data and language style data.

The system may include a specially programmed computer system comprising one or more computer processors, interactive interfaces, electronic storage devices, and networks.

The computer implemented system, method and medium described herein provide unique advantages to entities, organizations and other users, according to various embodiments of the invention. The innovative system and method provide real business benefits for client facing roles as early detection of negative client sentiment allows mitigation before it reaches a critical point. For example, the system may provide a notification or alert when a negative emotion is detected to enable an administrative to be proactive rather than reactive when trying to keep customers happy and/or satisfied. An embodiment of the present invention builds client management escalation and training tools based on developing natural language tone analyzers. The various embodiments of the present invention provide an opportunity to revolutionize the approach to human to human interaction across multiple lines of business, applicable to both internal as well as external communications. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flow diagram, according to an embodiment of the present invention.

FIG. 2 is an exemplary system diagram, according to an embodiment of the present invention.

FIG. 3 is an exemplary sentiment analysis interface, according to an embodiment of the present invention.

FIG. 4 is an exemplary client dashboard, according to an embodiment of the present invention.

FIG. 5 is an exemplary email validator interface, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to leveraging artificial intelligence (AI) technologies and algorithms to measure client emotions from natural language threads and messages, including emails, chat, texts, voice to text, posts, reviews, etc. For example, by taking text from a communication, such as an email, between a sender and a recipient, an embodiment of the present invention may process the received data using a Sentiment/Tone Analyzer. For example, a sender may include a manager, such as a Client Service Account Managers (CSAM) and a recipient may include external clients, peers, managers, supervisors, staff, contractors, etc. An exemplary application may involve Customer Service Account Managers (CSAM) in trader services dealing with external clients. The Sentiment/Tone Analyzer provides client sentiment scores for each communication and/or other text data across a plurality of emotions, such as Sadness, Joy, Disgust, Anger and Fear. These scores may then be displayed via an interactive interface, such as a dashboard, showing graphical indicators (e.g., traffic light icons, etc.) for client emotions. An embodiment of the present invention may provide an ability to drilldown to a client level to determine the emotional trends for that client. In addition, the innovative system provides training tools where users may extract and/or identify text excerpts from emails and other sources to be analyzed and emotionally scored by the Sentiment/Tone Analyzer before sending to clients.

An embodiment of the present invention may measure in real time client emotion and sentiment across various natural language and voice channels, email channels, telephone calls in multiple languages as well as other sources of text and other data. An embodiment of the present invention may consider cultural nuances and indicators as well as contextual markers.

An embodiment of the present invention may further scan real time chats and emails as they are being composed. The system may warn users when their language may be too strong, potentially offensive and/or upset the recipient before the message is sent. The system may also consider the intended recipient(s) (e.g., superior, client, group message, individual, etc.), context of the message (e.g., formal request, informal message, informational, etc.), past historical data involving recipient, type of recipient (e.g., internal, external, etc.) as well as other considerations. The system may also learn from past miscommunications, unintended reactions, etc. The system may highlight key words and/or phrases to alert the user and also provide recommendations/suggestions to improve and/or achieve a desired objective.

The innovative system further provides training tools that offer certain users, such as client facing staff, suggestions for improvements in communications to external clients. For example, in addition to spell checking, users may receive suggested improvements to make communications more impactful and better perceived by the recipient. For example, an objective may be identified where the Sentiment/Tone Analyzer may then process the communication in accordance with the objective. The objective may include a desired tone, e.g., professional, friendly, sympathetic, assertive, apologetic, persuasive, etc. The communication may include internal as well as external communications, e.g., social media, marketing, posts and/or other public communications.

An embodiment of the present invention may be directed to training a Sentiment/Tone model. For example, the Sentiment/Tone analyzer may be trained using actual client emails, messages, texts, writing samples, excerpts, publications, articles, documents and/or other training data. An embodiment of the present invention may be directed to trader services where managers communicate with external clients across the nation and around the world. In this example, the preferred language may be formal and professional. An embodiment of the present invention may develop a custom sentimental model using internal professional language. The sentiment scores may be based on a scale that translates to a sentiment, such as neutral, happy/please and angry/disappointed. For example, sentiment scores may be normalized on a scale between 0 and 1. Other ranges and/or scales may be applied. For each communication (e.g., email, etc.), a sentiment score may be derived that indicates a predominant sentiment along with a negative/positive indicator. An embodiment of the present invention may then determine an overall score for a set of communications. This may be for a particular client, user, group of users, time period, and/or other factor. An embodiment of the present invention may then determine a threshold (or set of threshold values) based on the sentiment scores where the threshold may represent a marker between a negative emotion and a positive emotion (as well as other sentiments). The threshold may be based on various factors and considerations and may further vary based on the data collected as well as the type of indicator.

The innovative system provides an ability to view and analyze a change in emotion over time and further pinpoint when and why emotion changes. An embodiment of the present invention may apply notifications in response to a change in sentiment. Upon identifying a negative emotion, an embodiment of the present invention may provide a notification or alert to a responsible manager or other user. This enables a proactive approach to addressing client sentiment issues.

An embodiment of the present invention may also match users (e.g., Client Services Account Managers (CSAMs)) with clients based on matching similar communication styles. This may be realized through a clustering algorithm that identifies similarities and commonalities among managers as well as among clients. By applying a clustering algorithm, an embodiment of the present invention may appropriately match users (e.g., managers) and clients as well as identify anomalies and outliers. An embodiment of the present invention may further identify trends and behaviors.

An embodiment of the present invention may actively scan people's perception of teams and applications to obtain live feedback (e.g., how a provider is doing and where the provider can improve, etc.). For example, an embodiment of the present invention may be applied to surveys relating to performance and overall satisfaction.

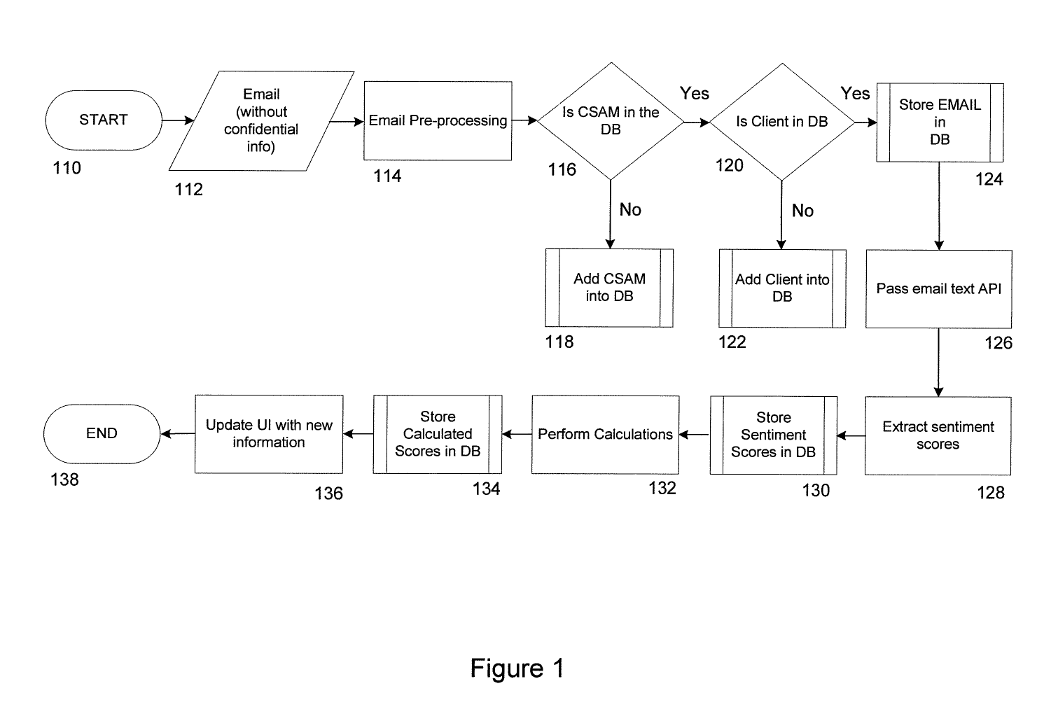

FIG. 1 is an exemplary flow diagram, according to an embodiment of the present invention. Step 110 represents a start of a client sentiment analyzer process. At step 112, an email (or other text source or communication) may be received. At step 114, the email may be preprocessed. This may involve extracting text, formatting text and/or other data parsing and/or filtering. At step 116, the system may determine whether a CSAM is known or otherwise in the Database. If not, the CSAM may be added to the database at 118. If yes, the system may determine whether the client is in the Database. If not, the client may be added to the database at 122. If yes, the email may be stored in database at 124. The email text may be passed to an API or other interface, at step 126. The system may extract one or more sentiment scores, at step 128. The sentiment scores may be stored in a Database at step 130. The system may perform calculations on the sentiment scores at step 132. The calculated scores may be stored at 134. An interactive user interface may be updated, at step 136. Step 138 represents an end of the process. FIG. 1 illustrates an example involving an email communication; however, other types of communications may be applied in accordance with the various embodiments of the present invention. The order illustrated in FIG. 1 is merely exemplary. While the process of FIG. 1 illustrates certain steps performed in a particular order, it should be understood that the embodiments of the present invention may be practiced by adding one or more steps to the processes, omitting steps within the processes and/or altering the order in which one or more steps are performed.

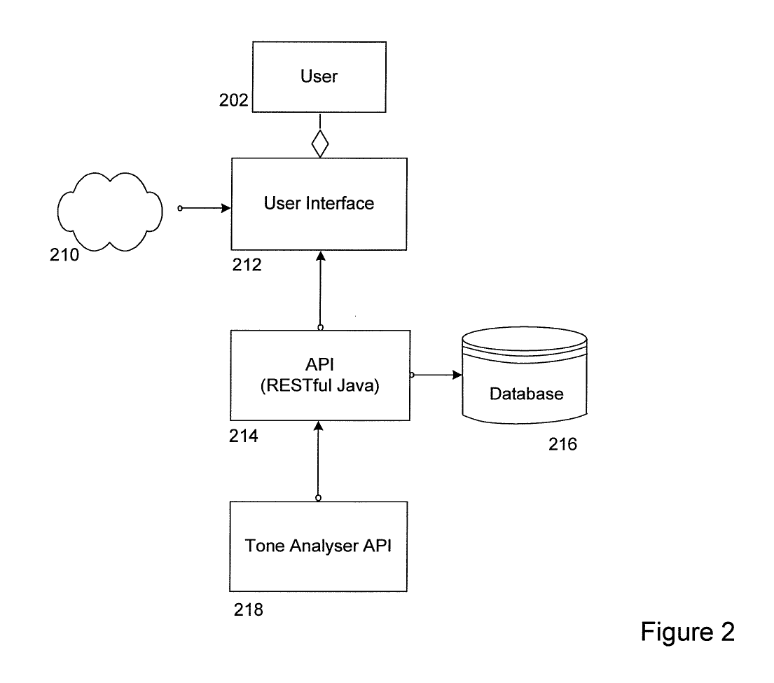

FIG. 2 is an exemplary system diagram, according to an embodiment of the present invention. As shown in FIG. 2, User Interface 212 may be hosted on a cloud server 210. User Interface 212 may include various web technologies, including Angular, TypeScript and Moneta Bootstrap, for example. Tone Analyzer API 218 may provide sentiment data to User Interface 212 via API 214. API 214 may store and/or access data via Database 216. User 202 may view and access data provided by User Interface 212 via various user devices.

According to an exemplary implementation, the innovative system may include various combinations of components. For example, Angular may represent a framework for building complex browser based web applications. TypeScript may provide support for types to JavaScript and compiles down to JavaScript. Angular applications are typically written in TypeScript. Bootstrap may represent a Cascading Style Sheets (CSS) framework for developing responsive web applications. Maven may represent a project management tool used to fetch Java dependencies and build an overall project into an artifact that is published to a Firmwide Nexus Repository. NPM may represent a package manager for NodeJS applications. Front-end tooling may be built using NodeJS and distributed as NPM modules. NodeJS may represent an open-source cross-platform JavaScript run-time environment that executes JavaScript code outside of a browser. Yarn represents an extension/replacement of NPM that maintains a lockfile for predictable dependency management and adds a cache layer for faster installs. Yarn is an Apache Hadoop technology and stands for Yet Another Resource Negotiator. Yarn represents a large-scale, distributed operating system for big data applications. Webpack analyzes web source files and repackages them into bundles with a variety of options. Spring Boot represents a bootstrapping and development of Spring applications. Other components, tools and architectures may be implemented in accordance with the various embodiments of the present invention.

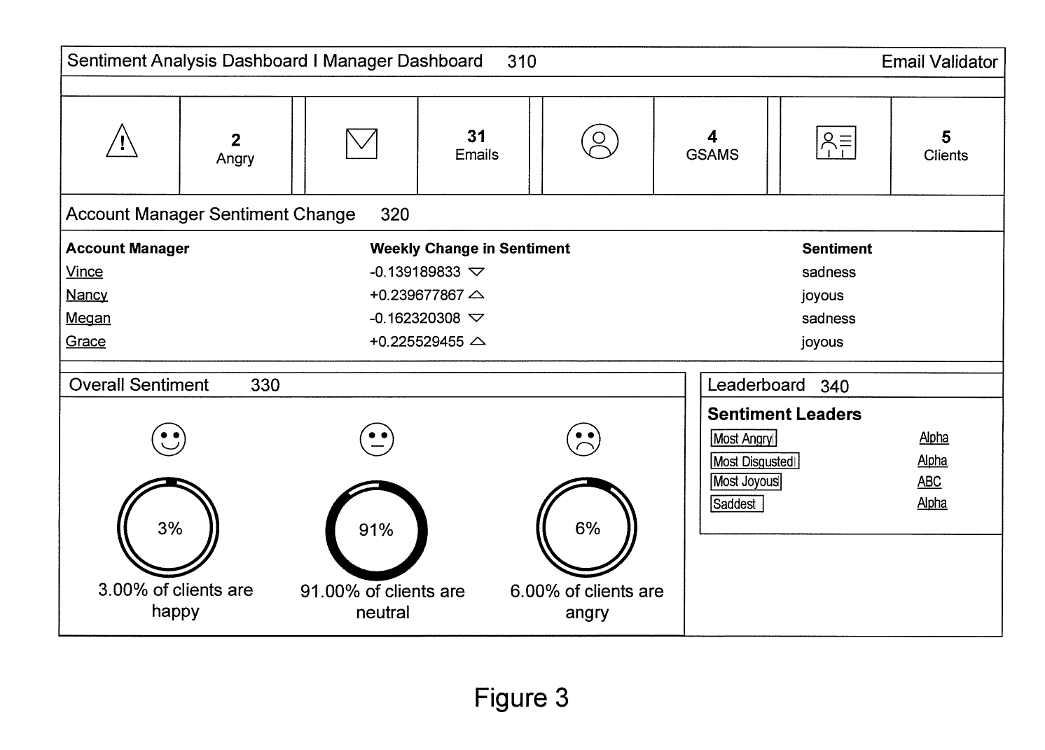

FIGS. 3-5 represent exemplary user interfaces, according to an embodiment of the present invention.

FIG. 3 is an exemplary sentiment analysis interface, according to an embodiment of the present invention. FIG. 3 illustrates Manager Dashboard 310, Account Manager Sentiment Change 320, Overall Sentiment 330 and Leaderboard 340. Manager Dashboard 310 provides a count of various metrics. In the exemplary illustration of FIG. 3, Manager Dashboard 310 includes a count of angry sentiment, a count of email communications, a number of GSAMs and a number of clients. Account Manager Sentiment Change 320 displays account managers, a measure of change in sentiment and a corresponding sentiment. For example, Account Manager Sentiment Change 320 illustrates a weekly change in sentiment. Other metrics may be calculated and displayed. Overall Sentiment 330 may graphically illustrate a percentage of clients in various categories. FIG. 3 shows a scenario where 3% of clients are deemed happy, 91% are neutral and 6% may be considered angry. Other metrics and calculations may be illustrated. For example, additional metrics and/or sentiments may be determined and displayed. Leaderboard 340 provides an indication of most angry, most disgusted, most joyous and saddest sentiment. Other indications may be identified and displayed.

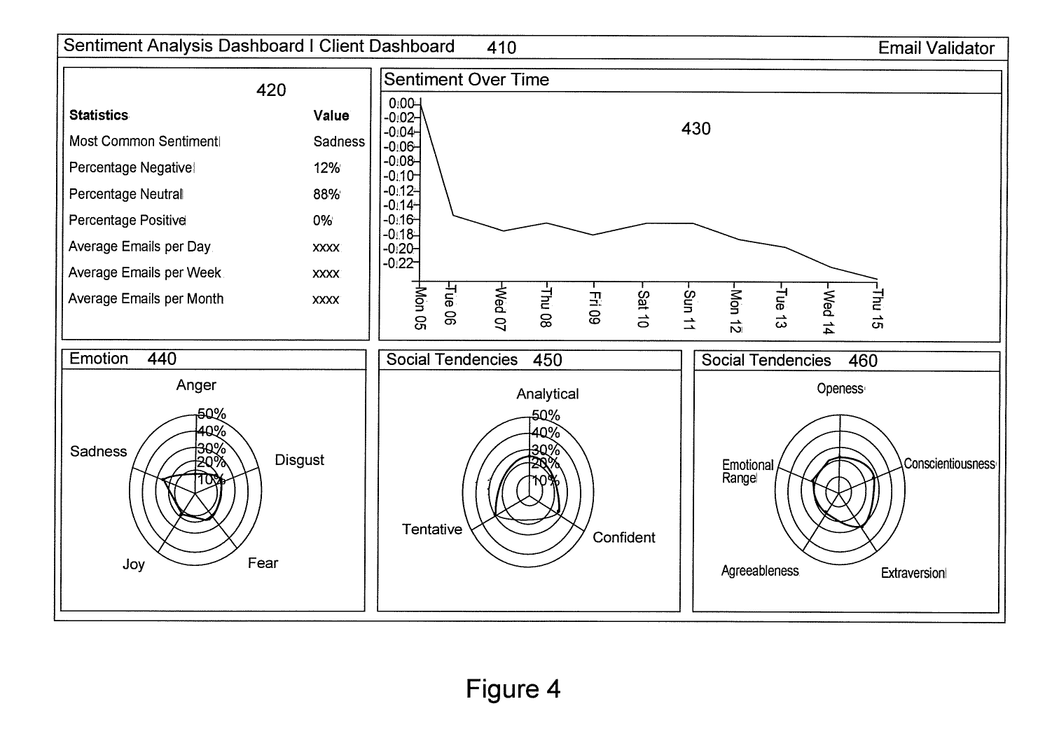

FIG. 4 is an exemplary client dashboard, according to an embodiment of the present invention. FIG. 4 illustrates Client Dashboard 410. Panel 420 displays Statistics and corresponding values. In the example shown in FIG. 4, statistics may include most common sentiment, percentage negative, percentage neutral, percentage positive, average emails per day, week and month. Sentiment Over Time 430 graphically illustrates sentiment over a predetermined period of time. This illustrates how sentiment changes along a timeline. In addition, FIG. 4 illustrates Emotion 440 and Social Tendencies 450, 460. Social Tendencies 450 may illustrate metrics including analytical, tentative and confident. Other social tendencies 460 may include Openness, Conscientiousness, Extraversion, Agreeableness and Emotional Range. Other metrics may be provided.

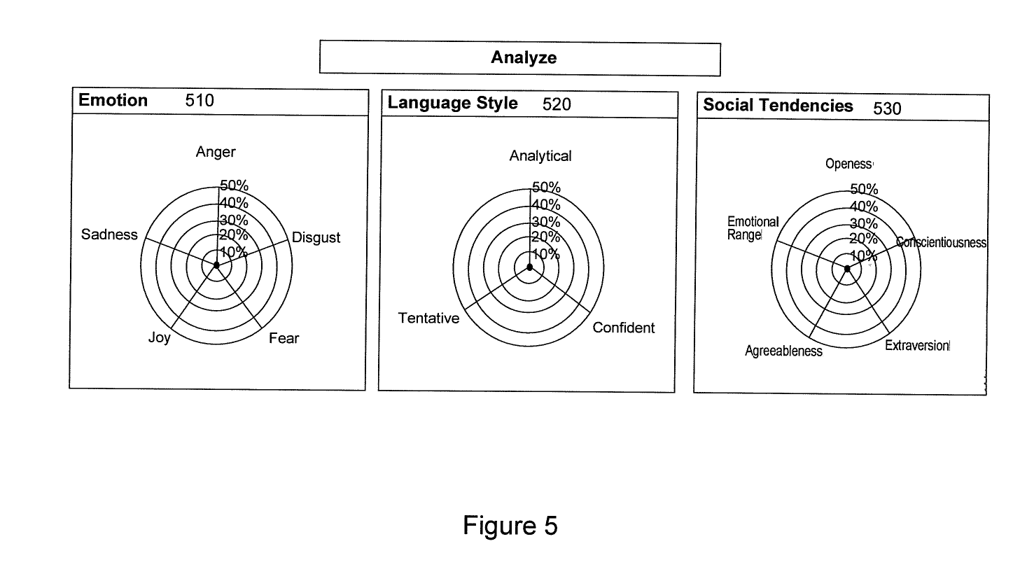

FIG. 5 is an exemplary email validator interface, according to an embodiment of the present invention. In this example, Sentiment Analyzer may provide details concerning Emotions 510, Language Style 520 and Social Tendencies 530. For example, Emotion 510 graphically illustrates how five representative emotions are represented in a communication, e.g., email Language Style 520 represents how three representative styles are represented in the communication. And, Social Tendencies 530 graphically illustrate how the five representative social tendencies are represented in the communication. Other metrics and representative indicators may be provided and may be further customized to address the user's objectives.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system for implementing a Sentiment Analyzer Tool, the system comprising:
a data repository that stores and maintains sentiment data;
a user interface that graphically presents metrics based on the sentiment data;
an application program interface in communication with the data repository and the user interface; and
a processor, coupled to the data repository, the user interface and application program interface, configured to perform the steps of:
receiving, via an electronic input, real-time customer communication;
extracting, via the processor, text data from the real-time customer communication;
generating, via the processor, a customer sentiment score based on the text data;
comparing, via the processor, the customer sentiment score to a threshold value to determine a positive sentiment, neutral sentiment or negative sentiment; and
graphically representing, via the interactive user interface, the customer sentiment score as compared to sentiment data associated with a plurality of other customers wherein the interactive user interface displays overall sentiment data, sentiment data over a predetermined period of time and a combination of: emotion data, social tendencies data and language style data.

2. The system of claim 1, wherein the processor is further configured to perform:
training, via the processor, a sentiment model that is customized for a specific application.

3. The system of claim 2, wherein the sentiment model is customized based on type of language, type of audience and intended sentiment objective.

4. The system of claim 1, wherein the threshold value is generated by comparing the real-time customer communication to a set of communications over a predetermined period of time.

5. The system of claim 1, wherein the processor is further configured to perform:
applying, via the processor, a clustering algorithm that aggregates a plurality of external communications that share one or more commonalities.

6. The system of claim 5, wherein the clustering algorithm determines one or more outlier communications.

7. The system of claim 1, wherein the interactive user interface displays a change in sentiment over a predetermined period of time.

8. The system of claim 1, wherein the customer communication comprises one or more of email communications, voice-to-text communications and text messages.

9. The system of claim 1, wherein the processor is further configured to perform the step of:
providing, via the processor, one or more recommendations to change a current sentiment associated with the customer communication.

10. The system of claim 1, wherein the processor is further configured to perform the step of:
transmit, via the processor, a notification in responsive to a negative sentiment.

11. A method for implementing a Sentiment Analyzer Tool, the method comprising the steps of:
receiving, via an electronic input, real-time customer communication;
extracting, via a processor, text data from the real-time customer communication;
generating, via the processor, a customer sentiment score based on the text data;
comparing, via the processor, the customer sentiment score to a threshold value to determine a positive sentiment, neutral sentiment or negative sentiment; and
graphically representing, via the interactive user interface, the customer sentiment score as compared to sentiment data associated with a plurality of other customers wherein the interactive user interface displays overall sentiment data, sentiment data over a predetermined period of time and a combination of: emotion data, social tendencies data and language style data.

12. The method of claim 11, further comprising the step of:
training, via the processor, a sentiment model that is customized for a specific application.

13. The method of claim 12, wherein the sentiment model is customized based on type of language, type of audience and intended sentiment objective.

14. The method of claim 11, wherein the threshold value is generated by comparing the real-time customer communication to a set of communications over a predetermined period of time.

15. The method of claim 11, further comprising the step of:
applying, via the processor, a clustering algorithm that aggregates a plurality of external communications that share one or more commonalities.

16. The method of claim 15, wherein the clustering algorithm determines one or more outlier communications.

17. The method of claim 11, wherein the interactive user interface displays a change in sentiment over a predetermined period of time.

18. The method of claim 11, wherein the customer communication comprises one or more of email communications, voice-to-text communications and text messages.

19. The method of claim 11, further comprising the step of:
providing, via the processor, one or more recommendations to change a current sentiment associated with the customer communication.

20. The method of claim 11, further comprising the step of:
transmit, via the processor, a notification in responsive to a negative sentiment.
